(19) United States
(12) Patent Application Publication
(10) Pub. No.: US 2006/0197020 A1
(43) Pub. Date: Sep. 7, 2006

(54) OPERATOR SAFETY DEVICE FOR A MACHINE HAVING SHARP IMPLEMENTS

(76) Inventors: Michael A. Trzecieski, Toronto, ON (CA); Hanna Trecieski, 25080 Manerba del Garda (BS) (IT)

Correspondence Address: Hanna Trecieski, Via Valtenesi 1/D, 25080 Manerba del Garda (BS), IT

(21) Appl. No.: 11/306,453

(22) Filed: Dec. 29, 2005

(30) Foreign Application Priority Data
Jan. 12, 2005 (EP) WO2005068896

(51) Int. Cl. G01J 5/02

(52) U.S. Cl. 250/342

(57) ABSTRACT

A novel human operator safety device is disclosed for use with motorized machines that have a danger zone that includes sharp cutting implements that can potentially cause operator harm. The operator safety device includes an optical or thermal sensor for either processing optically derived information to determine whether an extremity of an operator is within a predetermined proximity of the danger zone of the machine and processing thermal information to determine whether an extremity of an operator is within a predetermined proximity of the danger zone of the machine. If a presence is detected, at least a portion of the machine what may cause operator harm is stopped. For example, a thermal camera, an optical camera, laser or thermal sensor is used for determining whether an extremity of an operator is within a predetermined proximity of the danger zone.

This application claims priority from International Patent Application No. WO2005068896 filed Jan. 12, 2005, which claims priority from U.S. Provisional Application No. 60/481,883 filed on Jan. 12, 2004.

### FIELD OF THE INVENTION

The invention relates to the field of operator safety devices and more specifically to the field of operator safety devices for use with motorized machines that have sharp cutting implements that can potentially cause harm to a human operator.

### BACKGROUND OF THE INVENTION

Human operator safety is important in many industries that require a human operator to interact with a machine that has sharp cutting surfaces. For example, in the meat skinning industry, gripping roles and sharp skinning knives that are used within the skinning machine can seriously harm the human operator if their hands come in contact with the sharp cutting surfaces or knives of these machines. Of course, human operators are trained to avoid certain dangerous parts of these machines, but accidents do happen and a momentary lapse of concentration can result in serious injury.

Various operator safety devices are known to those of skill in the art and have been documented in patent literature. For example, U.S. Pat. No. 3,953,770 describes safety equipment for use with devices such as presses and shearing machines. In this patent an insulating mat in which a wire netting is embedded is placed for supporting the operator in front of the machine. A high-frequency electric signal is applied to the wire netting from a high-frequency electric power source in such a manner that a high-frequency electric field is formed around the operator standing on the mat. This high-frequency electric field is sensed by an antenna installed vicinity of the danger zone and when a part of the operator comes into contact with the danger zone, a control circuit and switching mechanism disables operation of the machine. U.S. Pat. No. 5,921,367 describes a safety device for a kneading machine using rolls. The safety device uses thermal detection or capacitive detection to detect the presence of an extremity of a human operator. Unfortunately, because the temperature of the material being kneaded is close to that of the temperature of the hand of the human operator, thermal detection thereof may not be attainable

Referring to U.S. Pat. No. 5,025,175, a safety means for powered machinery is described. The powered machinery includes a danger zone that for example utilizes cutting knives or other sharp implements that are used for processing of meat or other products that may cause harm to an extremity of a human operator if they come in contact therewith. For operator safety, the machine operator wears a conventional wire mesh safety glove. The wire mesh glove is connected using a wire or a wireless link to a control circuit. Upon the wire mesh glove physically coming in contact with the machine, the control circuit disables functionality of the machine in order not to cause harm to the operator. For example, the machine is a skinning machine, as is well known to those of skill in the art, where the sharp implements are used in removing of skin from a meat carcass of a portion thereof.

Unfortunately, operator safety devices such as those aforementioned either require the operator to wear a glove or they require the operator to be subject to electrical fields, which may not be desirable for some. If the operator is not careful when wearing the glove then any physically contact with the machine results in the machine to shut off and is not necessarily a result of the glove coming into proximity of the danger zone of the machine. A larger danger in wearing of gloves arises from the glove becoming entrapped in the danger zone of the machine. Because the glove is made from metal, the sharp implements likely do not cut the glove, instead they tear the glove from the hand of the operators and likely also remove skin from the operator's hand. In many machine shops it is forbidden to wear jewelry or gloves when working with machines such as lathes and milling machines, thus wearing a glove when working with a skinning machine, for example, poses a serious safety hazard.

A need therefore exists to provide an operator safety device that provides for operator safety and one that overcomes the deficiencies of the prior art. It is therefore an object of the invention to provide an operator safety device that operates in conjunction with a machine having a danger zone that includes at least a cutting implement.

### SUMMARY OF THE INVENTION

In accordance with the invention there is provided a n operator safety device comprising: a first thermal sensor disposed proximate a danger zone of a machine that includes at least a moving part that is actuated by a motor, the first thermal sensor comprising a first detection zone bordering the danger zone for sensing a temperature of at least an object within the first detection zone thereof and for providing first temperature data therefrom in dependence upon the temperature of the at least an object; and, a control circuit coupled with the thermal sensor for receiving the first temperature data and for providing a control signal to the motor in dependence upon the first temperature data, the motion of the at least a moving part in determined by the control signal for one of enabling and disabling operation of the motor for moving of the at least a moving part.

In accordance with the invention there is provided a method of providing operator safety comprising: sensing a temperature of at least an object in proximity of a danger zone, which comprises a portion of a machine that when operating can potentially cause harm to a human operator; determining whether the sensed temperature is within one of a first temperature range and a second temperature range that is different from the first temperature range; and operating a portion of the machine within the danger zone when the sensed temperature is within the first range and other than operating of the portion of the machine within the danger zone when the sensed temperature is within the second range.

In accordance with the invention there is provided an operator safety device comprising: a first sensor disposed proximate a danger zone comprising at least a moving part and having a first detection zone bordering the danger zone for sensing both an inanimate object and an animate object within the first detection zone thereof and for providing first data therefrom in dependence upon the sensed object and in dependence upon a differentiation between the inanimate and animate objects; and a control circuit coupled with the first sensor for receiving the first data and for providing a control signal for controlling motion of the moving part within the danger zone in dependence upon whether the sensed object is at least one of inanimate and animate, where the motion of the at least a moving part is stopped when the animate object is sensed in the first detection zone.

In accordance with the invention there is provided an operator safety device for use with a machine having a danger zone that includes at least a moving part that is actuated by a motor and can potentially cause harm to a human operator, the operator safety device comprising: a first thermal sensor disposed proximate the danger zone and having a first detection zone bordering the danger zone for sensing a temperature of at least an object within the first detection zone thereof and for providing first temperature data therefrom in dependence upon the temperature of the at least an object; and, a control circuit coupled with the thermal sensor for receiving the first temperature data and for providing a control signal to the motor in dependence upon the first temperature data, the motion of the at least a moving part based upon the control signal.

In accordance with the invention there is provided a method of providing operator safety when operating a machine having a danger zone that includes a portion of the machine that when operating can potentially cause harm to a human operator, the method comprising: sensing a temperature of at least an object in proximity of the danger zone of the machine; determining whether the sensed temperature is within one of a first temperature range and a second temperature range that is different from the first temperature range; operating a portion of the machine within the danger zone when the sensed temperature is within the first range and other than operating of the portion of the machine within the danger zone when the sensed temperature is within the second range.

In accordance with the invention there is provided an operator safety device for use with a machine having a danger zone that includes at least a moving part that can potentially cause harm to a human operator, the operator safety device comprising: a first sensor disposed proximate the danger zone and having a first detection zone bordering the danger zone for sensing both an inanimate object and an animate object within the first detection zone thereof and for providing first data therefrom in dependence upon the sensed object and in dependence upon a differentiation between the inanimate and animate objects; and a control circuit coupled with the first sensor for receiving the first data and for providing a control signal for controlling motion of the moving part in dependence upon whether the sensed object is at least one of inanimate and animate, where the motion of the at least a moving part is stopped when the animate object is sensed in the first detection zone.

In accordance with the invention there is provided a machine comprising a motorized implement for cutting, the machine comprising: a danger zone, which includes the implement for cutting; an operator safety device comprising: a first sensor disposed proximate the danger zone and having a first detection zone bordering the danger zone for sensing both an inanimate object and an animate object within the first detection zone thereof and for providing first data therefrom in dependence upon the sensed object and in dependence upon a differentiation between the inanimate and animate objects; and a control circuit coupled with the first sensor for receiving the first data and for providing a control signal for controlling motion of the motorized implement for cutting in dependence upon whether the sensed object is at least one of inanimate and animate nature, where the motion of the motorized implement is stopped when the animate object is sensed in the first detection zone.

In accordance with the invention there is provided an operator safety device for use with a machine having a danger zone that includes at least a moving part that can potentially cause harm to a human operator, the operator safety device comprising: a first sensor disposed proximate the danger zone and having a first detection zone bordering the danger zone for sensing a temperature of at least an inanimate object and an animate object within the first detection zone thereof and for providing first data therefrom in dependence upon the sensed temperature; a second sensor disposed proximate the danger zone and having a second detection zone bordering the danger zone for sensing a temperature of at least an inanimate object and an animate object within the second detection zone thereof and for providing second data therefrom in dependence upon the sensed temperature; and, a control circuit coupled with the first sensor and the second sensor for receiving the first data and the second data and for providing a control signal for controlling motion of the moving part in dependence upon whether the sensed object within at least one of the first and second detection zones is at least one of inanimate and animate, where the motion of the at least a moving part is stopped when the animate object is sensed.

### BRIEF DESCRIPTION OF THE DRAWINGS

Exemplary embodiments of the invention will now be described in conjunction with the following drawings, in which:

FIG. 1a illustrates a top view and FIG. 1b illustrates a perspective view of a first embodiment of the invention, an operator safety device that utilizes thermal detection;

FIG. 1c illustrates use of a machine, for example a meat skinning machine, where a human operator (not shown) pushes a meat carcass, or portion thereof, past detection zones and into the danger zone;

FIGS. 2a and 2b illustrate a second embodiment of the invention, where a first thermal sensor is in the form of a first thermal imaging camera and a second thermal sensor is in the form of a second thermal imaging camera;

FIG. 3 illustrates a third embodiment of the invention, which is a variation of the second embodiment of the invention, where instead of using two thermal imaging cameras, a single thermal imaging camera is disposed overhead of the machine;

FIGS. 4a, 4b, 4c and 4d illustrate a third embodiment of the invention, a dual laser and dual receiver system that is used to detect the presence of one of an animate object, such as an extremity and of a human operator, and an inanimate object;

FIG. 5 illustrates an application of the embodiments of the invention for use with a machine in the form of a band saw; and

FIGS. 6a and 6b illustrate an application of the embodiments of the invention for use with a machine 601 in the form of a table saw.

### DETAILED DESCRIPTION OF EMBODIMENTS OF THE INVENTION

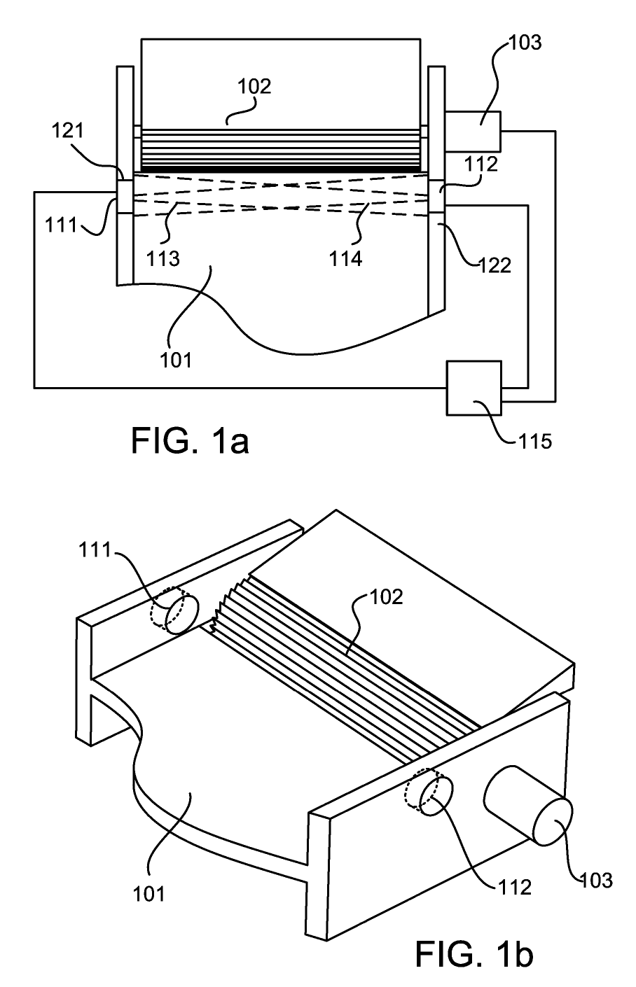

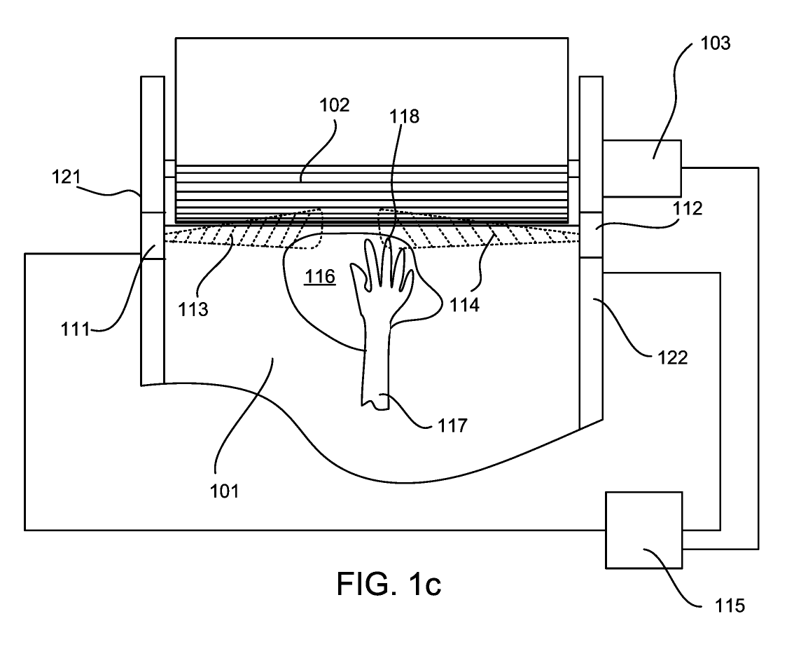

FIG. 1a illustrates a top view and FIG. 1b illustrates a perspective view of a first embodiment of the invention, an operator safety device that utilizes thermal detection. The operator safety device is disposed as part of a machine 101 having a danger zone 102. The danger zone includes for example cutting knives or other sharp implements that are used for processing of meat or other products that may cause harm to an extremity of a human operator if they come in contact therewith. In such machines, the cutting knives or other sharp implements are typically motorized using a motor 103 that is controlled using a control signal provided from a control circuit 115 for enabling and disabling operation thereof.

The operator safety device preferably comprises a first thermal sensor 111, a second thermal sensor 112 and the control circuit 115. The first thermal sensor 111 is disposed at a first position 121 in vicinity of the danger zone 102 of a machine 101. The second thermal sensor 112 is disposed at a second position 122 in vicinity of a danger zone 102 of the machine 101. The thermal sensors 111 and 112 face each other with overlapping first and second detection areas 113 and 114 formed therebetween. The first and second detection areas 113 and 114 border the danger zone 102 of the machine 101 and preferably overlap with a portion of the danger zone 102. The control circuit 115 is connected to each of the thermal sensors 111 and 112 and to a switch for enabling and disabling operation of the motor 103 actuating the motorized portion of the machine within the danger zone in response to the control signal. If the motorized portion of the machine within the danger zone 102 is not stopped when an extremity of the human operator comes in contact therewith (FIG. 1c) then human operator harm may result. Disabling operation of the motorized portion 103 of the machine 101 is detailed hereinbelow.

As illustrated in FIG. 1c, in use of the machine 101, for example a meat skinning machine, a human operator (not shown) pushes a meat carcass 116, or portion thereof, past the detection zones 113 and 114 and into the danger zone 102. Within the danger zone 102, blades and other sharp implements process the meat in accordance with the design of the machine 101. If an extremity of a human operator such as a hand 117, or portion thereof 118, is accidentally placed into the danger zone 102 then serious injury may result due to the sharp implements coming in contact with the extremity, 117 or 118. Thus, disabling of the motorized portion 103 of the machine 101 is preferable before such an injury results.

Meat carcasses 116 are typically chilled prior to being processed. Thus, the meat carcasses are at a temperature (T1) of approximately 4 degrees Celsius, typically under 10 degrees Ceicius, prior to being subject to processing by the machine 101 and are considered inanimate objects. The temperature of the human body (T2) is approximately 37.5 degrees Celsius and is considered being an animate object. Of course, extremities of a human operator such as the hands 117 and fingers 118 may have a lower temperature, especially if they are in contact with the chilled meat carcass 116 or a portion thereof, thus these extremities have a temperature of approximately over 10 degrees Celsius. However, the extremities 118 of the operator are at a higher temperature than that of the meat carcass 116 and thus are preferably thermally distinguishable therefrom. That said, when a meat carcass 116 is within the detection zones 113 and 114 of the temperature sensors 121 and 122, the temperature data received from the temperature sensors 121 and 122 falls within a first temperature range, for example below 10 degrees Celsius. However, if an extremity 118 of the human operator is within either of the detection zones 113 and 114 then at least one of the temperature sensors 121 or 122 registers a temperature of higher than, for example, 10 degrees Celsius, which is within the second temperature range and the control circuit 115 disables operation of the motorized portion 103 of the machine 101. By way of example, this process is detailed below.

Referring to FIG. 1c, in use, a human operator (not shown) grasps a meat carcass 116 and feeds a portion thereof into the machine 101. As the meat carcass 116 passes through the detection zones 113 and 114 the first and second thermal detectors 121 and 122 detect a temperature of the portion of the meat carcass 116 from either side thereof and provide first and second detected temperatures to the control circuit 115. Within the control circuit 115 a determination is made as to whether the first and second detected temperatures are within a first range, an inanimate object temperature range. While both detected temperatures are within the first range, the machine 101 and the motorized portion 103 thereof operates normally. However, once one of the first and second temperature data is within a second range, an animate object temperature range, the control circuit 115 immediately disables operation of the motorized portion 103 of the machine 101. Thus, if the control circuit 115 detects the presence of an extremity 117 of the human operator within the detection zones 113 and 114, such as fingers 118 in the second detection zone 114, motorized portions 103 of the machine used to drive the sharp implements in the danger zone 102 are disabled so that harm to the operator is unlikely. Once the extremity, such as the fingers 118 in this case, is removed from the detection zones 113 and 114, the first and second temperature data fall within the first range and operation of the motorized portion 103 of the machine 101 is optionally resumed.

Preferably first and second thermal sensors 121 and 122 are used with the machine 101 because when the meat carcass 116 obstructs one of the sensors then the other sensor detects the presence of the extremity, 117 or 118, of the human operator. In some cases both hands of the operator may be used to push the meat carcass 116 into the machine 101 and detecting from both sides of the meat carcass is preferable.

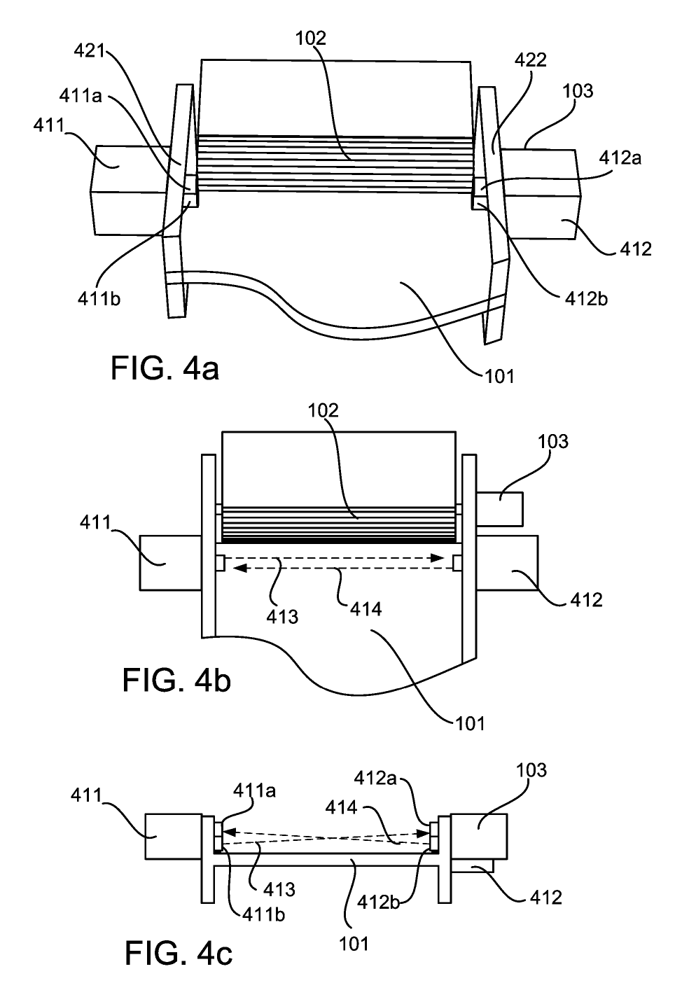

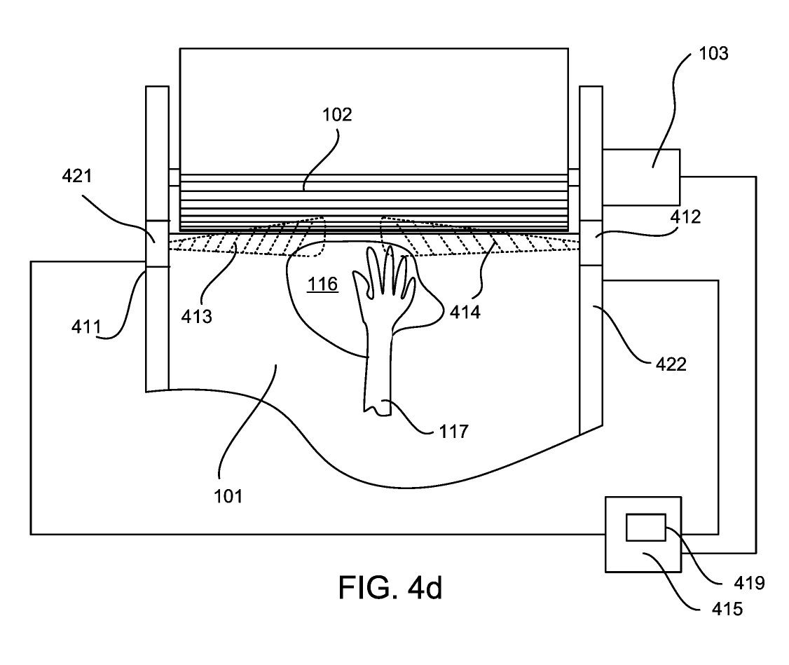

Optionally, an optical gate (not shown in FIG. 1c but a variation thereof is shown in FIGS. 4a, 4b and 4c) is disposed proximate the detection zones 113 and 114 and preferably parallel therewith. This optical get is used to determine whether there is an obstruction between the first and second thermal sensors 111 and 112. If so, then this obstruction is typically either a meat carcass 116 or an extremity of a human operator 117 or 118. If no obstruction is detected, then preferably the operation of the motorized portion 103 of the machine is stopped until an obstruction is detected. Thereby further increasing the safety of the machine 101 when it is not in use.

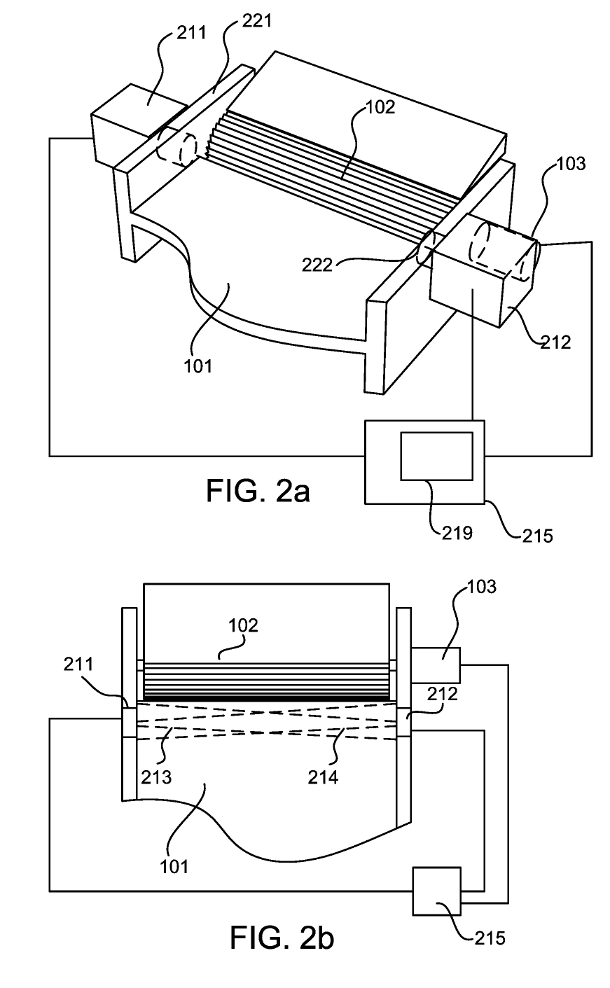

FIGS. 2a and 2b illustrates a second embodiment of the invention, where a first thermal sensor is in the form of a first thermal imaging camera 211 and optionally a second thermal sensor is in the form of a second thermal imaging camera 212. The first thermal imaging camera 211 is disposed at a first position 221 in vicinity of a danger zone 102 of a machine 101. The second thermal imaging camera 212 is disposed at a second position 222 in vicinity of the danger zone 102 of the machine 101 and preferably faces the first thermal imaging camera 211. Each thermal imaging camera provides its own detection zone, 213 and 214 respectively (FIG. 2b), which overlap with each other. These overlapping detection zones 213 and 214 border the danger zone 102 of the machine 101 and preferably overlap a portion of the danger zone 102. A processor 219 disposed within a control circuit 215 is coupled to each of the thermal imaging cameras 211 and 212 to process the thermal information received therefrom. A switching circuit disposed within the control circuit 215 is used for enabling and disabling operation of the motorized portion 103 of the machine 101.

Similarly to that illustrated in FIG. 1c, except that thermal cameras are utilized as a form of thermal sensors, an operator grasps the meat carcass 116 and feeds a portion thereof into the machine 101. As the meat carcass 116 passes through the detection zones 213 and 214 the first and second thermal imaging cameras 211 and 212 detect a temperature of the portion of the meat carcass 116 from either side thereof and provide first and second temperature image data to the processor 219. The processor 219 processes this first and second temperature image data and determines whether there is a presence of an extremity, 117 or 118, of the human operator anywhere within the detection zones 213 and 214 bordering the danger zone 102. If a presence is detected, then the control circuit 215 provides a control signal to the motorized portion 103 of the machine to disable operation thereof. Once the extremity, 117 or 118, of the human operator is removed and the processor 219 determines that this extremity is no longer within the detection zones 213 and 214, operation of the previously disable portion of machine 101 optionally resumes.

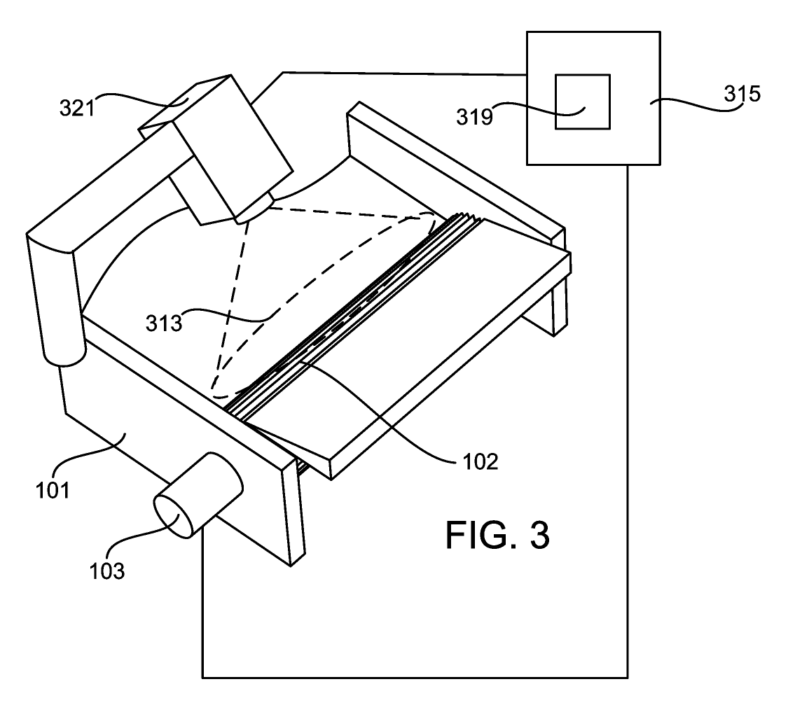

FIG. 3 illustrates a third embodiment of the invention, which is a variation of the second embodiment of the invention. Instead of using two thermal imaging cameras, a single thermal imaging camera 321 is disposed overhead, or on a side, of the machine 101. The single thermal imaging camera 321 is preferably positioned above the machine 101 and preferably fixed thereto in order to provide a detection zone 313 that borders the danger zone 102 and preferably overlaps with a portion of the danger zone 102. Additionally the single thermal imaging camera provides an unobstructed overhead view, or unobstructed side view, of the danger zone 102, as well as an unobstructed view of the area leading up to the danger zone. Software for executing within a processor 319 receives thermal information data from the thermal imaging camera 321 and processing algorithms are used to determine when the extremity of the human operator is found within the detection zone 313 that is in proximity of the danger zone 102. If the extremity is found then a control circuit 315 provides a control signal to the motorized portion of the machine 103 to disable operation thereof. Once the extremity of the human operator is removed and the processor 319 determines that the extremity is no longer within the detection zone 313, operation of the previously disable portion of machine 101 optionally resumes.

FIGS. 4a, 4b, 4c and 4d illustrate a third embodiment of the invention, a dual laser and dual receiver system that is used to detect the presence of one of an animate object, such as an extremity 117 and 118 of a human operator, and an inanimate object. A first laser and receiver pair 411 is disposed at a first position 421 in vicinity of a danger zone 102 of a machine 101. A second laser receiver pair 412 is disposed at a second position 422 in vicinity of the danger zone 102 of the machine 101 and preferably faces the first laser receiver pair, as shown in FIGS. 4b and 4c. The first laser receiver pair 411 includes a first laser 411a and a first optical receiver 411b. The second laser receiver pair 412 includes a second laser 412a and a second optical receiver 412b. As shown in FIG. 4c, the lasers and optical receiver are aimed such that without an obstruction between the two laser receiver pairs 411 and 412 the first laser 411a is aimed at the second optical receiver 412b and the second laser 412a is aimed at the first optical receiver 411b.

Upon providing an obstruction between the two laser receiver pairs, such as illustrated in FIG. 4d, the first laser receiver pair forms a first detection zone 413 and the second laser receiver pair forms a second detection zone 414. It is within these detection zones that the presence of an animate object is detected. These detection zones 413 and 414 border the danger zone 102 of the machine 101 and preferably overlap a portion thereof. A processor 419 is disposed within a control circuit 415. The control circuit 415 is coupled to each of the laser receiver pairs 411 and 412 controlling each laser and for receiving electrical signals representative of detected light at each of the optical receivers. A switching circuit disposed within the control circuit 415 is used for enabling and disabling operation of the motorized portion 103 of the machine 101.

Preferably, the laser receiver pairs detect the presence of an animate object by either determining blood flow within the animate object or by measuring a reflection of the laser light from human flesh. Of course other detection techniques used for detecting the presence of an animate object and for differentiating between animate and inanimate objects are also envisaged. Optionally, a laser is not used but an alternate light source that has an optical wavelength that is compatible with the optical receiver.

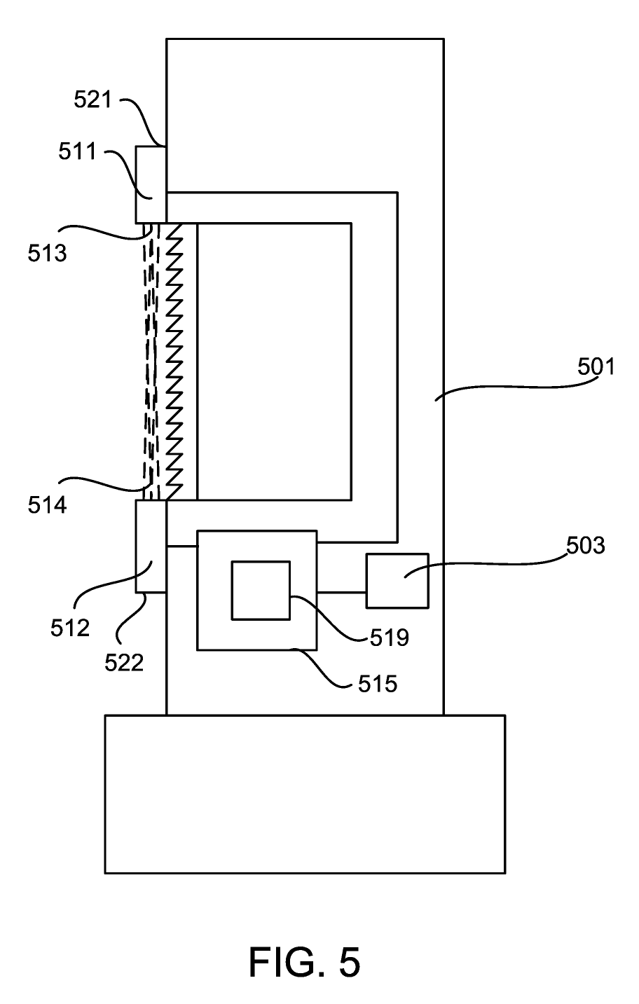

FIG. 5 illustrates an application of the embodiments of the invention for use with a machine 401 in the form of, for example, a bandsaw. A danger zone 502 is formed at a cutting surface of the bandsaw blade. A first thermal sensor 511 is disposed at a first position 521 in vicinity of a danger zone 502 of the machine 501. A second thermal sensor 512 is disposed at a second position 522 in vicinity of the danger zone 502 of the machine 501 and preferably faces the first thermal sensor 511. Each thermal sensor detects heat within its own detection zone, 513 and 514 respectively. The detection zones 513 and 514 overlap with each other. These overlapping detection zones 513 and 514 border the danger zone 502 of the machine 501 that includes the cutting blade. A processor 519 disposed within a control circuit 515 is coupled to each of the thermal sensors 511 and 512 to process the thermal information received therefrom. A switching circuit disposed within the control circuit 515 is used for enabling and disabling motion of the band saw blade by enabling and disabling of a motor 503 used to actuate the blade.

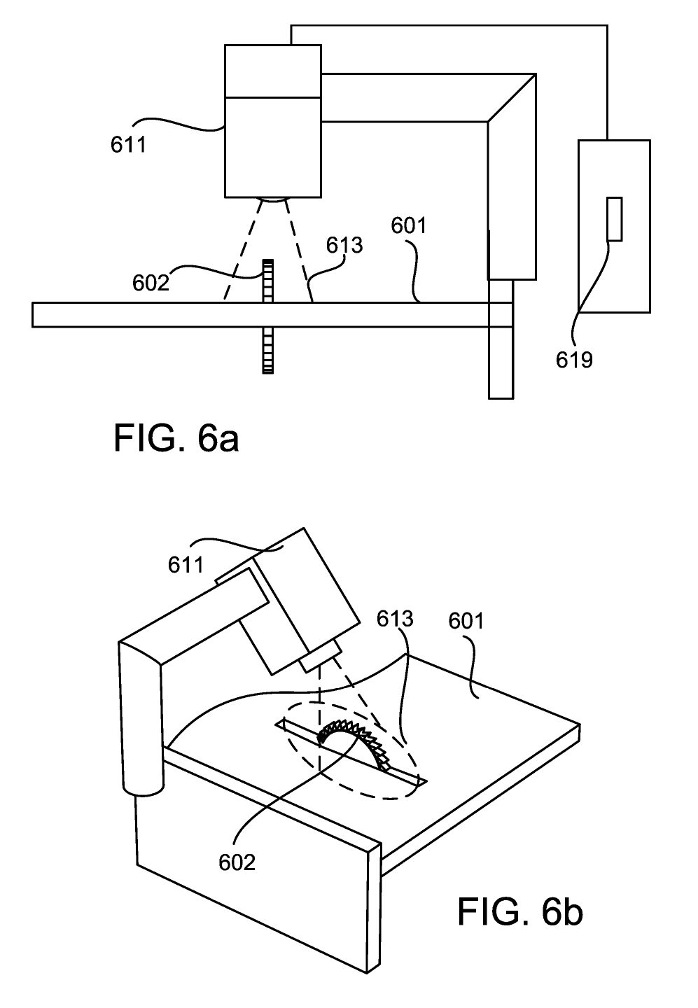

FIGS. 6a and 6b illustrate an application of the embodiments of the invention for use with a machine 601 in the form of a table saw. A danger zone 602 is formed at a cutting surface of the saw blade. A sensor 611, preferably in the form of a thermal imaging camera, is disposed overhead of the machine 601. The sensor 611 is preferably positioned above the machine 601 and preferably fixed thereto in order to provide a detection zone 613 that borders the danger zone 602 and preferably overlaps with a portion of the danger zone 602. Additionally the sensor 611 is provided with an unobstructed overhead view, or unobstructed side view, of the danger zone 602, as well as an unobstructed view of the area leading up to the danger zone 602. Software for executing within a processor 619 receives information data from the sensor 611, the data preferably derived from thermal information, and processing algorithms are used to determine when the extremity of the human operator is found within the detection zone 613 that is in proximity of the danger zone 602. If the extremity is found, then a control circuit 615 provides a control signal to the motorized portion of the machine 603 to disable saw blade rotation. Once the extremity of the human operator is removed and the processor 619 determines that the extremity is no longer within the detection zone 613, operation of the previously disable portion of machine 601 optionally resumes.

Of course, as material is being sawed using either the band saw or the table saw the temperature thereof is likely to increases. As a result, processing algorithms for execution within the processor preferably eliminate false readings and disable operation of the cutting blade of the machine 501, 601 when an extremity of the operator is found within the danger zone, 502 and 602. For the bandsaw illustrated in FIG. 5, optionally, instead of using two thermal sensors, or two thermal imaging cameras, a single thermal imaging camera or single thermal imaging sensor is disposed in order to detect the presence of an extremity of the human operator. Advantageously, by using thermal imaging to detect the presence of an animate object within a danger zone of a machine, hazards such a glove becoming entrapped in the sharp implements found in the danger zone are avoided. Furthermore, the thermal imaging and detection of animate objects allows for disabling of moving portions of the machine in order to reduce and to potentially eliminate human operator harm.

Numerous other embodiments may be envisaged without departing from the spirit or scope of the invention.

What is claimed is:

1. A device comprising:
a meat processing machine comprising a danger zone disposed from a first side to a second side thereof including a sharp implement and at least a moving part that is actuated by a motor, the meat processing machine for processing of at least a portion of a meat carcass having a first temperature range where the at least a portion of the meat carcass is periodically found within the danger zone, the meat processing machine for being operated by an operator having at least a body part within a second temperature range higher than the first temperature range where contact with the at least a body part of the operator with the sharp implement and the at least a moving part within the danger zone results in operator harm;
a first thermal sensor disposed at the first side of the meat processing machine and comprising a first detection zone bordering the danger zone from the first side;
a second thermal sensor disposed at the second side of the meat processing machine and comprising a second detection zone approximately overlapping with the first detection zone and bordering the danger zone from the second side, the first thermal sensor and second thermal sensor for receiving of infrared radiation from the at least a body part of the operator and the at least a portion of the meat carcass periodically found within the first detection zone and second detection zone and for respectively providing first and second temperature data therefrom in dependence upon the received infrared radiation;
a switching circuit for controllably one of enabling and disabling operation of the motor in dependence upon a control signal; and,
a control circuit coupled with the first thermal sensor and the second thermal sensor for receiving the first and second temperature data and for providing the control signal to the switching circuit in dependence upon the first and second temperature data, the motion of the at least a moving part determined by the control signal for one of enabling and disabling operation of the motor for moving of the at least a moving part such that when the at least a body part of the operator is within at least one of the first detection zone and second detection zone the operation of the motor is disabled and when the at least a portion of the meat carcass and other than the at least a body part of the operator is found within the at least one of the first detection zone and second detection zone the operation of the motor is enabled.

2. A device according to claim 1 wherein the temperature difference between the first temperature range and the second temperature range is approximately 5 degrees Celsius.

3. A device according to claim 1 wherein the temperature range of the at least a portion of the meat carcass is under approximately 10 degrees Celsius.

4. A device according to claim 1 wherein the temperature range of the body part of the human operator is over approximately 10 degrees Celsius.

5. A device according to claim 1 wherein the control circuit comprises a processor for receiving of the first and the second temperature data and for processing thereof for determining whether the at least a body part of the operator is found within the at least one of the first detection zone and the second detection zone for one of enabling and disabling operation of the motor in dependence thereon.

6. A device according to claim 5 wherein the first thermal sensor comprises a first thermal imaging camera for receiving of infrared radiation from within the first detection zone and where the first thermal data is derived from a visual representation of the infrared radiation, the processor coupled with the first thermal imaging camera for receiving of the visual representation of the infrared radiation and for processing thereof for determining whether the at least a body part of the operator is found within the first detection zone and for one of enabling and disabling operation of the motor in dependence thereon.

7. A device according to claim 5 wherein the second thermal sensor comprises a second thermal imaging camera for receiving of infrared radiation from within the second detection zone and where the second thermal data is derived from a visual representation of the infrared radiation, the processor coupled with the second thermal imaging camera for receiving of the visual representation of the infrared radiation and for processing thereof for determining whether the at least a body part of the operator is found within the second detection zone and for one of enabling and disabling operation of the motor in dependence thereon.

8. A device according to claim 1 wherein the second thermal sensor faces the first thermal sensor and the first detection zone and the second detection zone approximately overlap when other than the at least a portion of the meat carcass and other than the at least a body part of the operator is found within the first detection zone and the second detection zone.

9. A device according to claim 1 wherein at least one of the first detection zone and the second detection zone overlap with at least a portion of the danger zone.

10. A device according to claim 1 wherein the at least a body part of the operator is an animate object and the at least a portion of meat carcass is an inanimate object, where the control circuit is for distinguishing between the one of an animate and an inanimate object for controllably enabling and disabling operation of the motor when the animate object is detected within at least one of the first detection zone and the second detection zone.

11. A device comprising:
a meat processing machine comprising a danger zone disposed from a first side to a second side thereof including a sharp implement and at least a moving part that is actuated by a motor, the meat processing machine for processing of at least a portion of a meat carcass having a first temperature range where the at least a portion of the meat carcass is periodically found within the danger zone, the meat processing machine for being operated by an operator having at least a body part within a second temperature range higher than the first temperature range where contact with the at least a body part of the operator with the sharp implement and the at least a moving part within the danger zone results in operator harm;
a first light source disposed at the first side of the meat processing machine for providing of a first collimated light beam;
a second light source disposed at the second side of the meat processing machine for providing of a second light beam and facing the first light source;
a first optical receiver disposed at the first side of the meat processing machine for receiving one of the second collimated light beam and a reflection of the first collimated light beam for forming a first detection zone that borders the danger zone from the first side when the first collimated light beam is reflected from an object disposed within the first detection zone, the first optical receiver for providing of first data in dependence upon received light;
a second optical receiver disposed at the second side of the meat processing machine for receiving one of the first collimated light beam and a reflection of the second collimated light beam for forming a second detection zone that borders the danger zone from the second side when the second collimated light beam is reflected from the object disposed within the second detection zone, the second optical receiver for providing of second data in dependence upon received light, wherein the object is at least one of the at least a portion of a meat carcass and the at least a body part of the operator;
a switching circuit for controllably one of enabling and disabling operation of the motor in dependence upon a control signal; and,
a control circuit coupled with the first and second light sources for controlling thereof and coupled with the first optical receiver and the second optical receiver for receiving of the first and second data therefrom, where motion of the at least a moving part is determined by the control signal for one of enabling and disabling operation of the motor such that when the at least a body part of the operator is within at least one of the first detection zone and second detection zone the operation of the motor is disabled and when the at least a portion of the meat carcass and other than the at least a body part of the operator is found within the at least one of the first detection zone and second detection zone the operation of the motor is enabled.

12. A device according to claim 11 wherein the control circuit comprises a processor for receiving of the first and the second data and for processing thereof for determining whether the at least a body part of the operator is found within the at least one of the first detection zone and second detection zone in dependence upon the reflected light from the object and for one of enabling and disabling operation of the motor in dependence thereon.

13. A device according to claim 12 wherein at least one of the first and second data are in the form of blood flow data, where the controllable enabling and disabling of the operation of the motor is in dependence upon whether blood flow is detected within at least one of the first detection zone and second detection zone, the detection of blood flow within the at least a body part of the operator results in disabling operation of the motor and other than detection of blood flow results in enabling operation of the motor.

14. A device according to claim 12 wherein the first optical receiver comprises a first imaging camera responsive to the first collimated light beam for receiving one of the second light beam and a reflection of the first collimated light beam and for forming first image data in dependence thereon, the processor for processing of this first image data and for determining whether the object is at least one of the at least a portion of a meat carcass and the at least a body part of the operator and for disabling operation of the motor when the at least a body part of the operator is detected within the first detection zone.

15. A device according to claim 12 wherein the second optical receiver comprises a second imaging camera responsive to the second light beam for receiving one of the second light beam and a reflection of the second collimated light beam and for forming second image data in dependence thereon, the processor for processing of this second image data and for determining whether the object is at least one of the at least a portion of a meat carcass and the at least a body part of the operator and for disabling operation of the motor when the at least a body part of the operator is detected within the second detection zone.

16. A device according to claim 11 wherein at least one of the first light source and the second light source comprise at least a laser light source for providing at least one of the first and second collimated light beams.

17. A device according to claim 11 wherein the first detection zone and second detection zone overlap at least a portion of the danger zone.

18. A method comprising:
providing a meat processing machine comprising a danger zone disposed from a first side to a second side thereof including a sharp implement and at least a moving part that is actuated by a motor, the meat processing machine for processing of at least a portion of a meat carcass having a first temperature range where the at least a portion of the meat carcass is periodically found within the danger zone, the meat processing machine for being operated by an operator having at least a body part within a second temperature range higher than the first temperature range where contact with the at least a body part of the operator with the sharp implement and the at least a moving part within the danger zone results in operator harm;
providing of a first detection zone bordering the danger zone from a first side of the meat processing machine;
providing of a second detection zone bordering the danger zone from a second side of the meat processing machine and approximately overlapping with the first detection zone;
differentiating between a presence of at least a portion of a meat carcass and an extremity of a human operator within at least one of the first detection zone and second detection zone; and
one of controllably disabling operation of the motor when the at least a body part of the operator is disposed within at least one of the first detection zone and second detection zone and controllably enabling operation of the motor when the at least a portion of the meat carcass and other than the at least a body part of the operator is disposed within the first detection zone and second detection zone.

19. A method according to claim 18 wherein the differentiation comprises determining a presence of blood flow within at least one of the meat carcass and the at least a body part of the operator periodically found within the first detection zone and second detection zone, where upon detecting a presence of blood flow the operation of the motor is controllably disabled.

20. A method according to claim 18 wherein the differentiation comprises processing of infrared radiation received from at least one of the meat carcass and the at least a body part of the operator periodically found within at least one of the first detection zone and second detection zone, where upon detecting a presence of the at least a body part of the operator the operation of the motor is controllably disabled.
